(19) United States
(12) Patent Application Publication
(10) Pub. No.: US 2024/0382845 A1
(43) Pub. Date: Nov. 21, 2024

(54) INFORMATION PROCESSING DEVICE AND EXECUTION SWITCHING SYSTEM

(71) Applicant: SEGA CORPORATION, Tokyo (JP)

(72) Inventor: Satoshi MOTOIKE, Tokyo (JP)

(21) Appl. No.: 18/693,096

(22) PCT Filed: Jun. 28, 2022
(86) PCT No.: PCT/JP2022/025683

§ 371 Date: Mar. 18, 2024

(30) Foreign Application Priority Data
Sep. 23, 2021 (JP) 2021-154936

(51) Int. Cl. A63F 13/358; A63F 13/355

(52) U.S. Cl. CPC A63F 13/358; A63F 13/355; A63F 2300/534

(57) ABSTRACT

It is possible to execute a program smoothly and reduce the cost of an information processing device overall.

The information processing device comprises: a first determination means 92 which, while a program is being executed, determines whether or not the state of execution is in a state previous to a predetermined switching state; an instruction means 94 which, in the case when said determination is affirmative, outputs an instruction for executing the program by the other information processing device having performance characteristics different from the information processing device; a second determination means 96 which determines whether or not the state of execution is the predetermined switching state; and a switching means 98 which, in the case of an affirmative determination, switches, from the information processing device to the other information processing device, the transmission source that transmits execution results of the program to a terminal device.

### TECHNICAL FIELD OF INVENTION

The present invention relates to an information processing device and an execution switching system.

### BACKGROUND ART

Patent Document 1 discloses a so-called cloud game in which a game server (information processing device) executes a game program and transmits execution results to a terminal device possessed by a user, thereby providing a game to the user.

### PRIOR ART DOCUMENT

### Patent Document

Patent Document 1: JP 2020-092877 A1

### DISCLOSURE OF THE INVENTION

### Problem to be Solved by Invention

However, when a plurality of information processing devices disclosed in Patent document 1 are prepared on a cloud, there is a problem that each information processing device needs to have an enhanced performance in order to smoothly execute the game program and a large amount of cost is required. This problem is not limited to the game program but may similarly occur when another program is executed on the cloud.

The present invention has been made in view of such a problem, and an object thereof is to provide a server device and an execution switching system which is capable of smoothly executing the program as well as reducing the cost of the entire information processing device when preparing a plurality of information processing devices on the cloud.

### Means for Solving Problem

In order to solve the above-described problem, an information processing device according to a first aspect of the present invention is an information processing device capable of communicating with a terminal device operated by a user, and comprises an execution means for executing a program and transmitting execution results to the terminal devices as a request source when receiving the execution request from the terminal devices, a first determination means for determining, in the middle of execution of the program, whether or not the state of execution is a prior state of a predetermined switching state, an instruction means for outputting an instruction for causing the other information processing device having the different performances compared with the information processing device to execute the program in the case of a positive determination by the first determination means, a second determination means for determining whether or not the state of execution is a predetermined switching state after the instruction, and a switching means for switching a transmission source for transmitting execution results of the program to the terminal devices from the execution means to the other information processing device in the case of the positive determination by the second determination means.

In the information processing device according to a second aspect of the present invention, the instruction means outputs an instruction for causing an information processing device having a higher performance than that of the information processing device, as the other information processing device, to execute the program.

In the information processing device according to a third aspect of the present invention, the instruction means outputs an instruction for causing an information processing device having a lower performance than that of the information processing device, as the other information processing device, to execute the program.

In the information processing device according to a fourth aspect of the present invention, the switching means switches the transmission source from the execution means to the other information processing device and then ends the communication connection with the terminal device.

In the information processing device according to a fifth aspect of the present invention, the program is a game program, and the predetermined switching state includes a state in which a scene of the game is switched.

An execution switching system according to a sixth aspect of the present invention is an execution switching system comprising a plurality of information processing devices including the information processing device, and a server device, wherein the server device comprises a search means for searching the information processing device capable of executing the program indicated by identification information among a plurality of information processing devices when a search request including the identification information of the program is received from the terminal device, and a connection instruction means for outputting a connection instruction to the terminal device so as to preferentially connect the information processing device having the lowest performance among the information processing devices searched by the search means.

### Effect/Function of Invention

According to the present invention, the program can be smoothly executed as well as the cost of the entire information processing device can be reduced.

### BRIEF DESCRIPTION OF DRAWINGS

FIG. 1 is a block diagram schematically showing an example of an overall configuration of the execution switching system.

FIG. 2 is a block diagram schematically showing an example of a hardware configuration of the game server shown in FIG. 1.

FIG. 3 is a block diagram schematically showing an example of a hardware configuration of a first terminal device shown in FIG. 1.

FIG. 4 is a block diagram schematically showing an example of a hardware configuration of a second terminal device shown in FIG. 1.

FIG. 5 is a block diagram schematically showing an example of a hardware configuration of a matching server shown in FIG. 1.

FIG. 6 is a block diagram schematically showing an example of a functional configuration of the execution switching system, in particular, the matching server and the game server.

FIG. 7 is a flowchart illustrating an example of a flow of processing executed by the execution switching system when the execution result of an application is provided to the user of the second terminal device.

FIG. 8 shows a processing subsequent to the processing shown in FIG. 7.

### EMBODIMENTS FOR CARRYING OUT INVENTION

Hereinafter, a plurality of embodiments of the present invention will be described with reference to the accompanying drawings. In order to facilitate understanding of the description, the same components and steps in each drawing are denoted by the same reference numerals as much as possible, and the repeated description is omitted.

### <Entire Configuration>

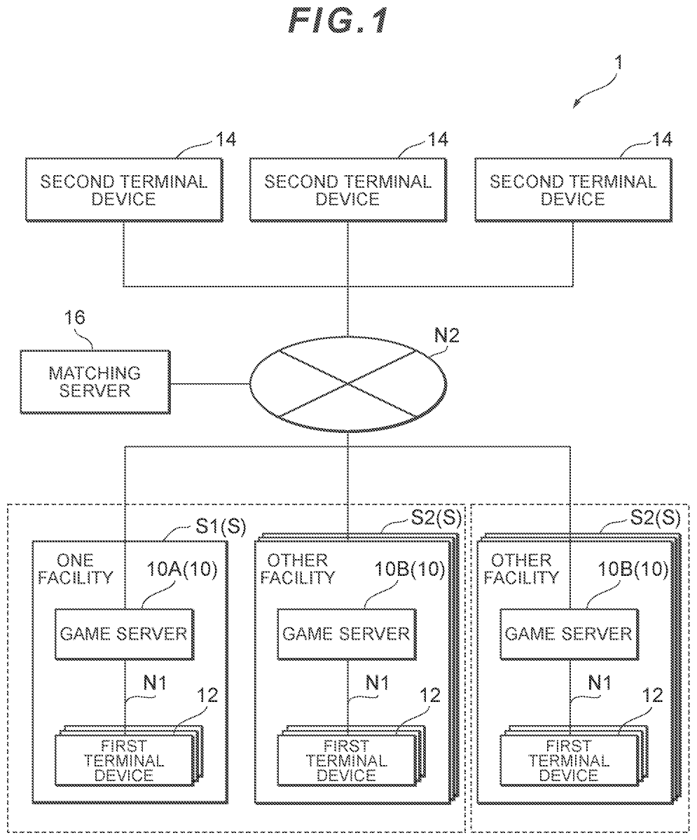

FIG. 1 is a block diagram schematically showing an example of an entire configuration of an execution switching system 1. As shown in FIG. 1, the execution switching system 1 includes a plurality of game servers 10 as an example of information processing device, a plurality of first terminal devices 12, a plurality of second terminal devices 14, and a matching server 16 as a server device. Among them, the game servers 10 and the first terminal devices 12 are configured to communicate with each other via a local area network N1 which is an example of a communication network. The game servers 10, the second terminal devices 14 and the matching server 16 are configured to be capable of communicating with one another via a wide area network N2 as an example of a communication network.

The game servers 10 are disposed in a plurality of facilities S such as one facility S1 and the other facilities S2. Hereinafter, the game server 10 disposed in one facility S1 is optionally referred to as “one game server 10A”, and the game server 10 disposed in the other facilities S2 is optionally referred to as “the other game server 10B”. These game servers 10 execute the game program and provide the game which is the execution result to the user of the first terminal devices 12 and the user of the second terminal devices 14. Further, the performance of the game servers 10 and the communication speed of the game servers 10 to the second terminal devices 14 differ depending on the type and location of the facility S. The facility S can be a game arcade, an accommodation facility, an amusement facility, a leisure facility and a data center, for example.

The first terminal device 12 is disposed in each facility S. This first terminal device 12 receives the game from the game server 10. Then, the first terminal device 12 accepts the operation of the user when the user plays the received game, and transmits the operation information to the game server 10.

The second terminal device 14 is outside the facility S and carried and operated by the user, for example. This second terminal device 14 receives the game from the game server 10. Then, the second terminal device 14 accepts the operation of the user when the user plays the received game. The second terminal device 14 can be a mobile phone, a smartphone, a tablet, and a personal computer, for example.

The matching server 16 matches the user with one or more game servers among a plurality of game servers 10 when the user of the second terminal device 14 plays the game.

### <Hardware Configuration>

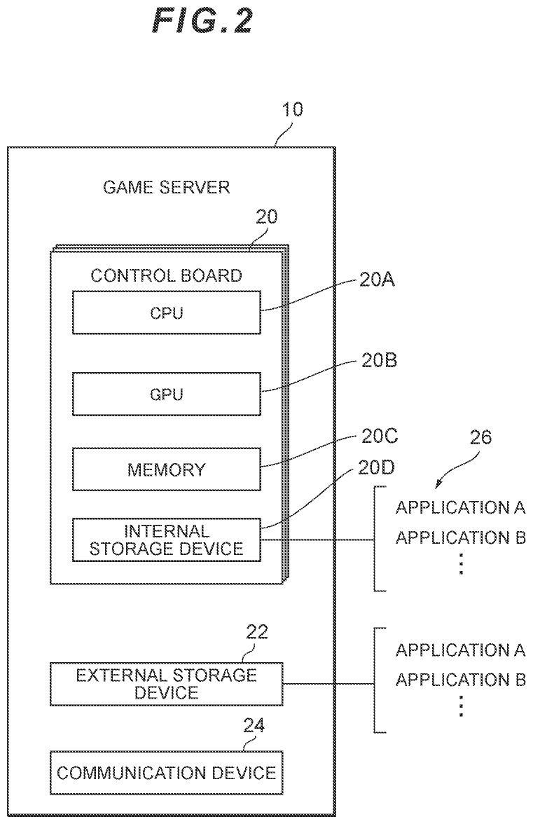

FIG. 2 is a block diagram schematically showing an example of a hardware configuration of the game server 10 shown in FIG. 1. As shown in FIG. 1, the game server 10 includes a control board 20, an external storage device 22 and a communication device 24.

The control board 20 has a higher performance and is more expensive than the control board 30 of the first terminal device 12, and is integrated in the game server 10. Specifically, it is preferable that the same number or more of control boards 20 as the number of first terminal device 12 are integrated. This control board 20 is electrically connected via a bus (not shown) to the external storage device 22 and the communication device 24. The control board 20 includes a CPU (Central Processing Unit) 20A, a GPU 20B, a memory 20C and an internal storage device 20D. The CPU 20A can execute an application program 26 (hereinafter, referred to as an “application 26”). The GPU 20B performs a calculation processing necessary for performing an image depiction. The memory 20C is a storage device which temporarily expands the application 26 executed by the CPU 20A. The internal storage device 20D is constituted by a hard disk and the like. The internal storage device 20D stores some types of applications 26, such as an application A and an application B, corresponding to the facility S and demands. The application 26 can be a game program, an image analysis program, a weather analysis program, an automatic driving program and an inspection program, for example. In the present embodiment, the application 26 is assumed as the game program.

The external storage device 22 is constituted by a hard disk and the like. This external storage device 22 stores applications 26 equal to or more than the number of applications 26 stored in the internal storage device 20D. For example, when the number of applications 26 stored in the internal storage device 20D is about 20 to 30, the number of applications 26 stored in the external storage device 22 is 100 or more, although this depends on the storage capacities of the storage device. The application 26 stored in the external storage device 22 is installed in the internal storage device 20D as necessary, for example, when the user uses it.

The communication device 24 is constituted by, for example, a communication interface for communicating with an external device. For example, the communication device 24 transmits and receives various kinds of information to and from the first terminal device 12.

The game server 10 may comprise a single information processing device, or may comprise a plurality of information processing devices distributed on the communication network. In addition, FIG. 2 only shows part of the main hardware configuration of the game server 10, and the game server 10 can include, for example, other configurations that are generally included in the server device.

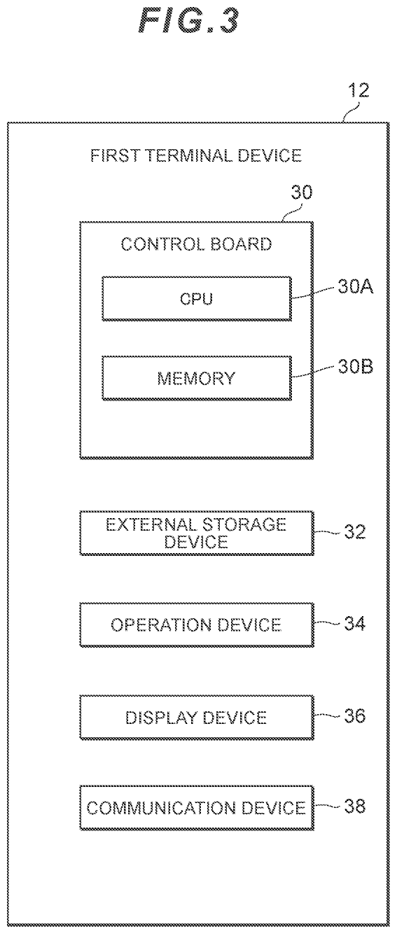

FIG. 3 is a block diagram schematically showing an example of the hardware configuration of the first terminal device 12 shown in FIG. 1. As shown in FIG. 3, the first terminal device 12 includes a control board 30, an external storage device 32, an operation device 34, a display device 36 and a communication device 38.

The control board 30 is electrically connected to the external storage device 32, the operation device 34, the display device 36 and the communication device 38 via a bus (not shown). This control board 30 includes a CPU 30A and a memory 30B. The CPU 30A can reproduce an advertisement video and the like. The memory 30B can temporarily expand the program.

The external storage device 32 stores data such as advertisement video.

The operation device 34 receives the operation of the user and inputs the operation information to the first terminal device 12.

The display device 36 displays execution results of the application 26 by the game server 10, for example, a game image.

The communication device 38 is constituted by, for example, a communication interface for communicating with an external device. The communication device 38 transmits and receives various types of information to and from the game server 10, for example.

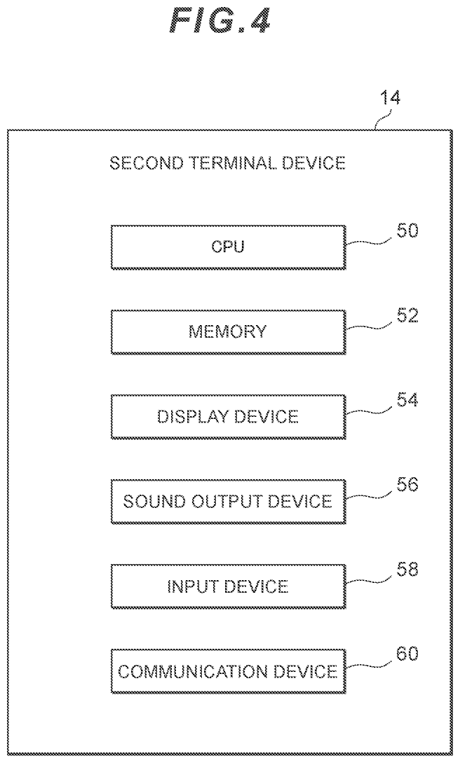

FIG. 4 is a block diagram schematically showing an example of the hardware configuration of the second terminal device 14 shown in FIG. 1. As shown in FIG. 4, the second terminal device 14 includes a CPU 50, a memory 52, a display device 54, a sound output device 56, an input device 58 and a communication device 60.

The CPU 50 is electrically connected to the memory 52, the display device 54, the sound output device 56, the input device 58 and the communication device 60 via a bus (not shown). This CPU 50 controls each device to be connected.

The memory 52 stores various data and various programs.

The display device 54 displays the game screen of the video game.

The sound output device 56 outputs the game sound of the video game.

The input device 58 inputs the operation information of the user to the second terminal device 14.

The communication device 60 is constituted by a communication interface for communicating with an external device, etc. The communication device 60 transmits and receives various types of information to and from the game server 10, for example.

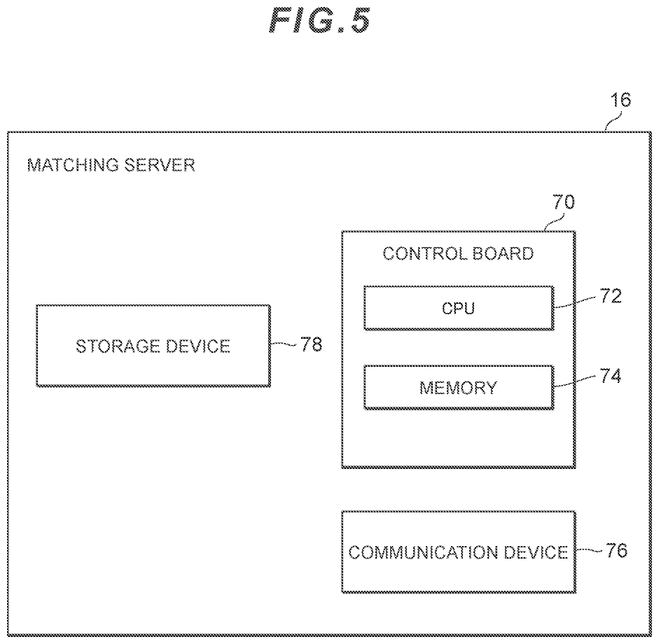

FIG. 5 is a block diagram schematically showing an example of the hardware configuration of the matching server 16 shown in FIG. 1.

As shown in FIG. 5, the matching server 16 includes a control board 70, a communication device 76 and a storage device 78. The control board 70 mainly includes a CPU (Central Processing Unit) 72 and a memory 74.

In the control board 70, the CPU 72 executes a predetermined program stored in the memory 74, the storage device 78 and the like to function as various functional configurations. Details of this functional configuration will be described later.

The communication device 76 includes, for example, a communication interface for communicating with an external device. For example, the communication device 76 transmits and receives various kinds of information to and from the second terminal device 14.

The storage device 78 is constituted by a hard disk and the like. The storage device 78 stores various programs and various types of information necessary for executing the processing in the control board 70, and information of processing results.

The matching server 16 can be realized with the information processing device such as a dedicated or general-purpose server computer. Further, the matching server 16 may be configured by a single information processing device, or may be configured by a plurality of information processing devices distributed on the communication network NT. In addition,

FIG. 5 only shows part of the main hardware configuration of the matching server 16, and the matching server 16 can include other configurations that are generally included in the server.

### <Functional Configuration>

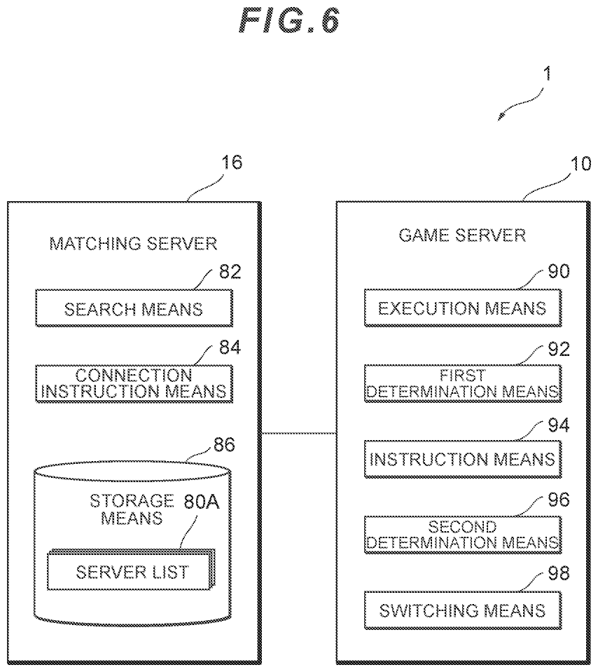

FIG. 6 is a block diagram schematically showing an example of the functional configuration of the execution switching system 1, in particular, the matching server 16 and the game server 10. As shown in FIG. 6, the matching server 16 includes, as the functional configuration, a storage means 80, a search means 82, and a connection instruction means 84. These functional configurations are realized with the execution of the program by CPU 72. The game server 10 also includes an execution means 90, a first determination means 92, an instruction means 94, a second determination means 96 and a switching means 98. These functional configurations are realized with the execution of the program by CPU 20A.

The storage means 80 serves to store, for example, a server list 80A and user information 80B. In the server list 80A, names of a plurality of facilities S, communication connection information such as IP addresses (Internet Protocol Address) of the game server 10 arranged in each facility S, and performances of the game server 10 arranged in each facility S are described for each area. The user information 80B includes information such as names, ages, user IDs, passwords and contact addresses, for each user of the first terminal devices 12 and for each user of the second terminal devices 14. The performance of the game server 10 can be a value such as a throughput, a response time and an operation rate which is determined from the performance of CPU 20A, the performance of GPU 20B, the performance of memory 20C, and the like, and the level of the performance is represented by the magnitude of the above-mentioned value. In the server list 80A, at least one of the above-mentioned values is described as the performance of the game server 10.

When the search means 82 receives a search request including identification information of the application 26 from the second terminal device 14, it serves to search the game server 10 capable of executing the application 26 indicated by the identification information, among a plurality of game servers 10.

The connection instruction means 84 serves to output, to the second terminal device 14, a connection instruction to preferentially connect the game server 10 having the lowest performance or the lowest communication speed among the game servers 10 searched by the search means 82, based on, for example, the server list 80A.

The execution means 90 serves to execute the application 26 when receiving an execution request from the second terminal device 14 and transmit execution results to the second terminal device 14 which is the request source.

The first determination means 92 serves to determine, while the application 26 is being executed, whether or not the state of execution is a prior state of a predetermined switching state. This predetermined switching state includes, for example, a state in which a processing of heavy load is started, a state in which a processing of light load is started, a state in which operations of a plurality of users are started in competition or cooperation in the same scene, and/or a state in which the scene of the game is switched.

When the first determination means 92 makes a positive determination, the instruction means 94 serves to output the instruction to execute the application 26 to the other information processing device having the different performance in comparison with the game server 10 which is currently executing the application 26 (hereinafter, referred to as “one game server”) or the different communication speed to the second terminal device 14.

Specifically, the instruction means 94 may output the instruction for causing the other game server having the higher performance than that of the one game server or the higher communication speed to the second terminal device 14, as the other information processing device, to execute the application 26. In addition, the instruction means 94 outputs the instruction for causing the other game server having the lower performance than the one game server or the lower communication speed to the second terminal device 14 than the one game server, as the other information processing device, to execute the application 26. The other information processing device may include not only the other game server but also the second terminal device 14.

The output destination of the instruction may be the second terminal device 14 or the other game server, but in the present embodiment, the case in which the output destination is the second terminal device 14 is described.

The second determination means 96 serves to determine whether or not the state of execution is a predetermined switching state after the instruction from the instruction means 94.

The switching means 98 serves to switch the transmission source for transmitting the execution result of the application 26 to the second terminal device 14 from the execution means 90 to the other game server when the second determination means 96 makes the positive determination. Examples of the method for switching the transmission source are outputting the switching instruction to the second terminal device 14 and outputting the switching instruction to the other game server, but in the present embodiment, the case in which the switching instruction is output to the second terminal device 14 is described.

Further, the switching means 98 may terminate the communication connection with the second terminal device 14 after switching the transmission source from the execution means 90 to the other game server.

### <Flow of Processing>

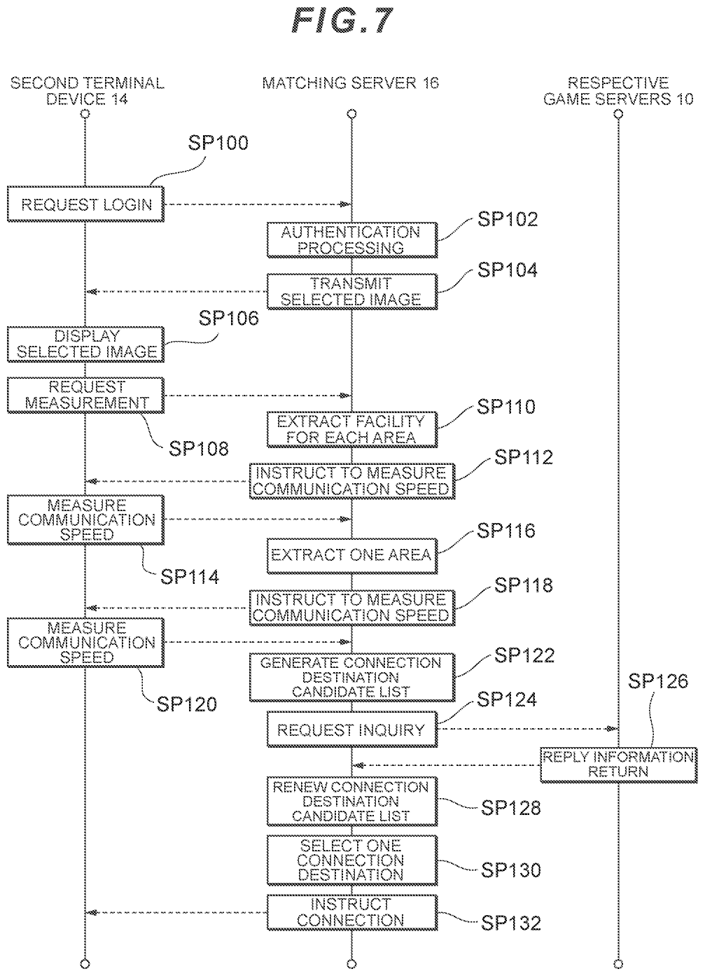

FIG. 7 is a flowchart illustrating an example of the flow of processing executed by the execution switching system 1 when the execution result of an application is provided to the user of the second terminal device 14. The content and order of the following processing can be changed as appropriate. When the execution result of the application 26 is provided to the user of the first terminal device 12, in principle, the game server 10 of the facility S where the first terminal device 12 is located is used. However, the game server 10 that provides the execution result of the application 26 to the user of the first terminal device 12 may be matched by the same processing as described below.

### (Step SP100)

When receiving the operation of the user, the second terminal device 14 transmits a login request including the user ID, the password, the IP address and the like of the user to the matching server 16. Then, the processing proceeds to step SP102.

### (Step SP102)

The matching server 16 receives the login request from the second terminal device 14. In response to this, the matching server 16 executes an authentication processing based on the user ID and password included in the login request and the user information 80B stored in the storage means 80. When the authentication processing is successful, the processing proceeds to step SP104. When the authentication processing is unsuccessful, an error is output to the second terminal device 14, and then a series of processing illustrated in FIG. 7 ends.

### (Step SP104)

The matching server 16 transmits a plurality of applications 26, that is, selected images on which names etc. of a plurality of game programs are described to the second terminal device 14 which is the request source. Then, the processing proceeds to step SP106.

### (Step SP106)

The second terminal device 14 receives the selected image from the matching server 16. In response to this, the second terminal device 14 displays the received selected image on the display device 54. When this selected image is displayed, the user of the second terminal device 14 selects one game program among a plurality of game programs described in the selected image. Then, the processing proceeds to step SP108.

### (Step SP108)

When receiving the selection of the game program from the user, the second terminal device 14 transmits a measurement request of the communication speed to the matching server 16. Then, the processing proceeds to step SP110.

### (Step SP110)

The matching server 16 receives the measurement request from the second terminal device 14. In response to this, the search means 82 of the matching server 16 extracts one facility from a plurality of facilities S for each area. For example, when the facility representing the respective areas is registered in the server list 80A, the matching server 16 extracts one representative facility from a plurality of facilities S for the respective areas. Then, the processing proceeds to step SP112.

### (Step SP112)

The matching server 16 acquires the respective IP addresses from the server list 80A as the communication connection information of the game servers 10 of the extracted facilities. Subsequently, the matching server 16 outputs (transmits), to the second terminal device 14, a measurement instruction for measuring the communication speed between the game server 10 of one facility extracted for each area and the second terminal device 14. The measurement instruction includes the IP address of the game server 10 of each facility acquired by the matching server 16. Then, the processing proceeds to step SP114.

### (Step SP114)

The second terminal device 14 receives the measurement instruction from the matching server 16. In response to this, the second terminal device 14 measures the communication speed between the second terminal device 14 and the game server 10 of one facility extracted for each area, based on each IP address included in the measurement instruction. Subsequently, the second terminal device 14 transmits the measurement result of the communication speed to the matching server 16. Then, the processing proceeds to step SP116.

### (Step SP116)

The matching server 16 receives the measurement result from the second terminal device 14. In response to this, the search means 82 extracts one area linked to the facility indicating the measurement result with the highest communication speed among the received measurement results. Then, the processing proceeds to step SP118.

### (Step SP118)

The matching server 16 acquires the respective IP addresses from the server list 80A as the communication connection information of the game servers 10 of a plurality of facilities S linked to the extracted one area. Subsequently, the matching server 16 outputs (transmits), to the second terminal device 14, a measurement instruction for measuring the communication speed between the second terminal device 14 and the game servers 10 of a plurality of facilities S linked to the one area. The measurement instruction includes the respective IP addresses acquired by the matching server 16. Then, the processing proceeds to step SP120.

### (Step SP120)

The second terminal device 14 receives the measurement instruction from the matching server 16. In response to this, the second terminal device 14 measures the communication speed between the second terminal device 14 and the game servers 10 of a plurality of facilities S linked to the one area is measured, respectively, based on the respective IP addresses included in the measurement instruction. Subsequently, the second terminal device 14 transmits, to the matching server 16, a search request including the identification information of the game program of which the selection is received in step SP106 and the measurement result of the communication speed measured in this step SP120. Then, the processing proceeds to step SP122.

### (Step SP122)

The matching server 16 receives the search request from the second terminal device 14. In response to this, the search means 82 of the matching server 16 searches the game server 10 satisfying a predetermined recommended communication speed among the game servers 10 of a plurality of facilities S linked to the one area, based on the measurement result of the communication speed included in the received search request, and lists the search result and the IP address to generate a connection destination candidate list. Then, the processing proceeds to step SP124.

### (Step SP124)

The search means 82 transmits an inquiry request of the operation state to the respective game servers 10 of the connection destination included in the generated connection destination candidate list. Then, the processing proceeds to step SP126.

### (Step SP126)

The respective game servers 10 receive the inquiry request from the matching server 16. In response to this, the respective game servers 10 transmit the current and/or future operation state (operation reservation state) to the matching server 16. Then, the processing proceeds to step SP128.

### (Step SP128)

The matching server 16 receives the operation state from the respective game servers 10. In response to this, the search means 82 renews the connection destination candidate list on the basis of the operation state. Subsequently, the connection instruction means 84 of the matching server 16 renews the connection destination candidate list so as to be able to instruct the second terminal device 14 to preferentially use (connect to) the game server having the lowest performance among the game servers 10 in the connection destination candidate list. Specifically, the connection instruction means 84 renews it so that the game servers 10 in the connection destination candidate list are in order of the game server having the lower performance. At least two or more game servers 10 having the different performances are described in this connection destination candidate list. Then, the processing proceeds to step SP130.

### (Step SP130)

The connection instruction means 84 transmits the connection instruction including the connection destination candidate list to the second terminal device 14 of the request source. Then, the processing proceeds to step SP200.

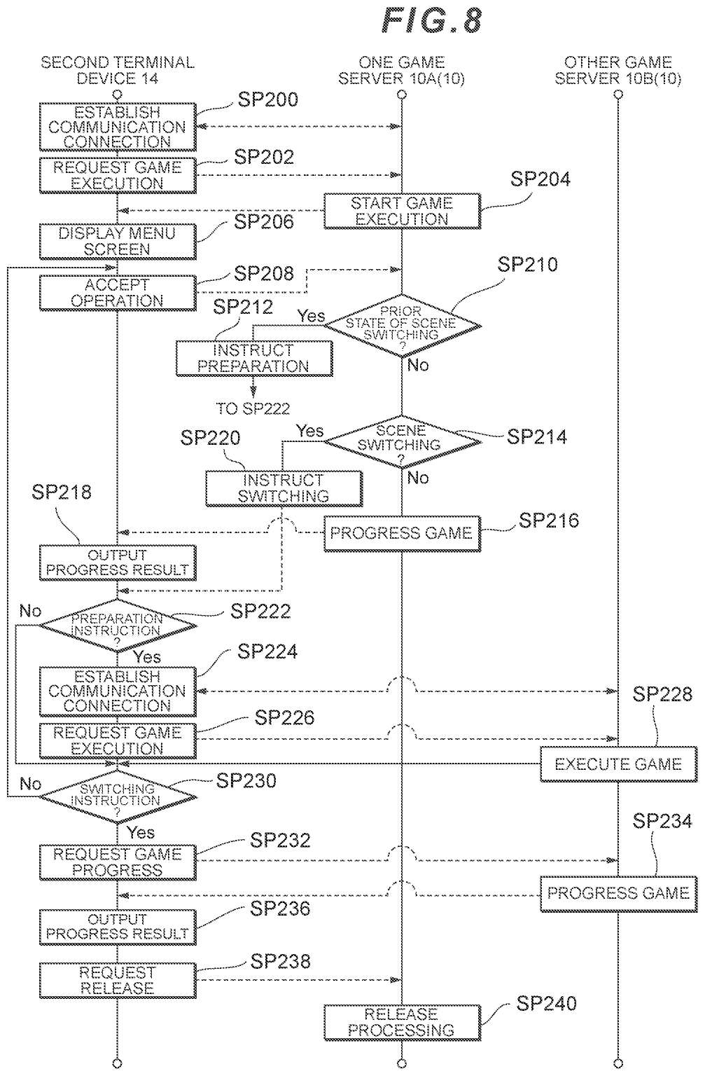

FIG. 8 shows the processing subsequent to the processing shown in FIG. 7.

### (Step SP200)

The second terminal device 14 receives the connection instruction from the matching server 16. In response to this, the second terminal device 14 attempts to establish the communication connection based on the IP address in order of the game server 10 described first in the connection destination candidate list included in the connection instruction, in other words, in order of the game server 10 having the lowest performance in the connection candidate list. In the following description, it is assumed that the second terminal device 14 establishes the communication connection with the lowest-performance game server 10, and the game server 10 with which the communication connection is established is referred to as one game server 10A. Then, the processing proceeds to step SP202.

### (Step SP202)

The second terminal device 14 accepts the payment of the game play fee from the user, gives a predetermined number of credits to the user, and then transmits a game execution request to the one game server 10A. Then, the processing proceeds to step SP204.

### (Step SP204)

The one game server 10A receives the execution request from the second terminal device 14. In response to this, the one game server 10A consumes a predetermined number of credits of the user depending on the type of the game program, and starts to execute the game program. Subsequently, the game server 10 transmits menu screen data as the execution result of the game program to the second terminal device 14 as the request source. Then, the processing proceeds to step SP206.

### (Step SP206)

The second terminal device 14 receives the menu screen data from the one game server 10A. In response to this, the second terminal device 14 displays the menu screen of the game on the display device 36 based on the received menu screen data. Then, the processing proceeds to step SP208.

### (Step SP208)

The second terminal device 14 accepts the operation of the user via the input device 58. In response to this, the second terminal device 14 transmits the operation information of the received operation to the one game server 10A. Then, the processing proceeds to step SP210.

### (Step SP210)

The one game server 10A receives the operation information from the second terminal device 14. In response to this, the first determination means 92 of the one game server 10A determines whether or not the state of execution of the game program is a prior state of the predetermined switching state. This prior state is, for example, a situation where the selection of quest is being received, a situation where the selection of character or object is being received, and a situation where a deck organization of character or object is being received, i.e., a situation before the screen is switched into the screen of the main game, such as quest, versus game and racing game. When the determination is positive, the processing proceeds to step SP212. When the determination is negative, the processing proceeds to step SP214.

### (Step SP212)

The instruction means 94 of the one game server 10A transmits a preparation instruction for switching the execution of the game program to the second terminal device 14 as the request source. To be more specific, the instruction means 94 instructs the other game server 10B having a higher performance than the one game server 10B to execute the same game program as the game program being executed by the execution means 90. Then, the processing proceeds to step SP222.

### (Step SP214)

After the preparation instruction, the second determination means 96 of the one game server 10A determines whether or not the state of execution of the game program is a predetermined switching state, that is, a state in which the scene of the game is switched. Examples of the situation in which the scene is switched include a situation in which the main game, such as quest, versus game and racing game, has started, a situation in which a complicated screen display is started, and a situation in which a battle with a boss character is started. When the determination is positive, the processing proceeds to step SP220, and when the determination is negative, the processing proceeds to step SP216.

### (Step SP216)

The execution means 90 progresses the game based on the operation information received in step SP210, and transmits the progress result to the second terminal device 14 that is the request source. Then, the processing proceeds to step SP218.

### (Step SP218)

The second terminal device 14 receives the progress result from the game server 10A. In response to this, the second terminal device 14 outputs the progress result to the display device 54, the sound output device 56 and the like. Then, the processing proceeds to step SP222.

### (Step SP220)

When the second determination means 96 makes a positive determination, the switching means 98 outputs a switching instruction to the second terminal device 14 so as to switch the transmission source for transmitting the execution result of the game program to the terminal device 14 from the execution means 90 to the other game server 10B. Then, the processing proceeds to step SP222.

### (Step SP222)

The second terminal device 14 determines whether or not there is a preparation instruction from the game server 10A. When the determination is positive, the processing proceeds to step SP224, and when the determination is negative, the processing proceeds to step SP230.

### (Step SP224)

The second terminal device 14 refers to the connection destination candidate list included in the connection instruction received in step SP200, and acquires the IP addresses of other game servers 10B having the higher performance than the one game server 10A. From the viewpoint of smoothly performing the execution processing in the scene after the switching, it is preferable that the second terminal device 14 acquires the IP addresses of the other game servers 10B that are at least twice as high-performance as the one game server 10A. Subsequently, the second terminal device 14 establishes the communication connection with the other game server 10B based on the acquired IP address. Then, the processing proceeds to step SP226.

### (Step SP226)

The second terminal device 14 transmits the execution request for the game program, including identification information of the same game program as the game program being executed by the execution means 90, to the other game server 10B with which the communication connection has been established. Then, the processing proceeds to step SP228.

### (Step SP228)

The other game server 10B receives the execution request from the second terminal device 14. In response to this, the other game server 10B starts to execute the game program indicated by the identification information included in the execution request. Subsequently, the other game server 10B transmits the fact that the execution of the game program has been started to the second terminal device 14. Then, the processing proceeds to step SP230.

### (Step SP230)

The second terminal device 14 determines whether or not there is a switching instruction from the one game server 10A. When the determination is positive, the processing proceeds to step SP232, and when the determination is negative, the processing returns to step SP208.

### (Step SP232)

The second terminal device 14 transmits the game progress request including the progress state of the game by the execution means 90 to the other game server 10B which is executing the game program. Then, the processing proceeds to step SP234.

### (Step SP234)

The other game servers 10B receive the progress requests from the second terminal device 14. In response to this, the other game server 10B synchronizes the progress state of the currently executed game with the progress state included in the progress request. Subsequently, the other game server 10B progresses the game from the middle of the game executed in the one game server 10A, and transmits the progress result to the second terminal device 14. Thus, the user can smoothly play the game without interrupting the game in the middle. Then, the processing proceeds to step SP236.

### (Step SP236)

The second terminal device 14 receives the progress results from the other game servers 10B. In response to this, the second terminal device 14 outputs the received progress result. Then, the processing proceeds to step SP238.

### (Step SP238)

The second terminal device 14 transmits a release request to the one game server 10A. Then, the processing proceeds to step SP240.

### (Step SP240)

The one game server 10A receives the release request. In response to this, the switching means 98 of the one game server 10A ends the communication connection with the terminal device 14, and releases the one game server 10A so as to be connected to the other terminal devices 14.

### <Effect>

As described above, according to the present embodiment, the one game server 10A capable of communicating with the second terminal devices 14 operated by the user comprises an execution means 90 for executing a program and transmitting execution results to the second terminal devices 14 as a request source when receiving the execution request from the second terminal devices 14, a first determination means 92 for determining, in the middle of execution of the program, whether or not the state of execution is a prior state of a predetermined switching state, an instruction means 94 for outputting an instruction for causing the other game servers 10B having the different performances compared with the one game server 10A to execute the program in the case of a positive determination by the first determination means 92, a second determination means 96 for determining whether or not the state of execution is a predetermined switching state after the instruction, and a switching means 98 for switching a transmission source for transmitting the execution result of the program to the second terminal devices 14 from the execution means 90 to the other game servers 10B in the case of a positive determination by the second determination means 96.

According to this configuration, since in a case where the state of execution of the program is the predetermined switching state the transmission source for transmitting the execution result of the program to the second terminal device 14 is switched from the execution means 90, that is, the one game server 10A to the other game server 10 having different performances, the execution result of the program can be continuously transmitted to the user. Here, by lowering the performance of the one game server 10A or the other game server 10 and switching to the other game server 10 when a high performance is required or when a high performance is not required, the program can be smoothly executed and the cost of the entire game server 10 can be reduced.

Further, when the state of execution of the program in the middle of the execution of the program is a prior state of the predetermined switching state, the other game server 10B having the different performance from the one game server 10A executes the program. Hence, as compared with a case where the transmission source for transmitting the execution result of the program is suddenly switched from the execution means 90, that is, the one game server 10A to the other game server 10 having the different performance, the execution result can be transmitted to the user without an interruption, and the stress on the user can be reduced.

Further, according to the present embodiment, the instruction means 94 outputs an instruction for causing the game server having a higher performance than that of the one game server 10A, as the other game server 10B, to execute the program.

According to this configuration, when the higher performance as the game server is required at the predetermined switching state, it is possible to output the instruction for causing the game server having the higher performance than the one game server 10A, as the other game server 10B, to execute the program. Therefore, the one game server 10A can be made low-performance and inexpensive, and the cost of the entire game servers 10 can be reduced. In addition, when it is not the prior state of the predetermined switching state, it is possible to save resources of the other game server 10B having a high performance by operating the one game server 10A having a low performance.

Further, according to the present embodiment, the instruction means 94 outputs an instruction for causing the game server 10B having a lower performance than that of the one game server 10A, as the other game server 10B, to execute the program.

According to this configuration, when a higher performance as the game server is not required in the predetermined switching state, it is possible to output an instruction for causing the game server having the lower performance than the one game server 10A, as the other game server 10B to execute the program. Therefore, the other game servers 10B can be made low-performance and inexpensive, and the cost of the entire game servers 10 can be reduced.

According to the present embodiment, the switching means 98 ends the communication connection with the one game server 10A after switching the transmission source from the execution means 90 to the other game server 10B.

According to this configuration, since the one game server 10A is released from the terminal device 14 and can communicate with the other terminal device 14 to execute a new game, it is possible to efficiently operate the one game server 10A.

According to the present embodiment, the program is a game program, and the predetermined switching state includes a state in which the scene of the game is switched.

According to this configuration, in case that the scene of the game is switched, even if a time lag occurs in the transmission of the execution result when the transmission source for transmitting the execution result of the program to the terminal device 14 is switched from the execution means 90 to the other game server 10B, the stress on the user can be reduced.

According to the present embodiment, an execution switching system 1 comprises a plurality of game servers 10 including the game server 10A and a matching server 16, and the matching server 16 includes a search means 82 for searching the game server capable of executing the program indicated by identification information among a plurality of game servers 10 when a search request including the identification information of the application 26 is received from the second terminal device 14, and a connection instruction means 84 for outputting a connection instruction to the second terminal device 14 so as to preferentially connect an information processing device having the lowest performance among the game servers searched by the search means 82.

According to this configuration, it is possible to save resources of the other game servers 10B having a higher performance.

### Modification Example

The present invention is not limited to the above-described embodiments. That is, those skilled in the art would appropriately modify the above-described embodiments, and such modifications are also included in the scope of the present invention as long as they have the features of the present invention. In addition, the respective elements included in the above-described embodiments and the modification examples described below can be combined as long as it is technically possible, and the combination is also included in the scope of the present invention as long as it includes the features of the present invention.

For example, in the above-described embodiment, a case in which the information processing device that executes the application 26 is the game server 10 has been described. However, the information processing device may be a server device disposed in a datacenter, an inspection device disposed in a factory, a device mounted on a vehicle, a device mounted on a robot and the like.

In the above embodiment, a case in which the game server 10 executes the application (game program) has been described. However, instead of the game server 10, the first terminal device 12 or the second terminal device 14 may execute the game program. In this case, the terminal device that executes the game program includes the execution means 90, the first determination means 92, the instruction means 94, the second determination means 96 and the switching mean 98, and performs the same processing as the game server 10. In the above-described embodiment, the game server 10 switches the execution of the game program from the one game server to the other game server 10, but the terminal device switches the execution of the game program from the game server 10 to the terminal device, or from the terminal device to the game server 10.

<Additional remark>

The additional remark concerning the present invention contains the following.

### [Additional Note 1]

An information processing device capable of communicating with a terminal device operated by a user, comprising:
an execution means for executing a program and transmitting execution results to the terminal devices as a request source when receiving the execution request from the terminal devices, a first determination means for determining, in the middle of execution of the program, whether or not the state of execution is a prior state of a predetermined switching state,
an instruction means for outputting an instruction for causing the other information processing device having the communication speed different from that of the terminal device compared with the information processing device to execute the program in the case of a positive determination by the first determination means,
a second determination means for determining whether or not the state of execution is a predetermined switching state after the instruction, and
a switching means for switching a transmission source for transmitting execution results of the program to the terminal devices from the execution means to the other information processing device in the case of the positive determination by the second determination means.

### [Additional Note 2]

The information processing device according to Additional Note 1, wherein the instruction means outputs an instruction for causing an information processing device having a higher communication speed to the terminal device in comparison with the information processing device, as the other information processing device, to execute the program.

### [Additional Note 3]

The information processing device according to Additional Note 1, wherein the instruction means outputs an instruction for causing an information processing device having a lower communication speed to the terminal device in comparison with the information processing device, as the other information processing device, to execute the program.

### LIST OF REFERENCE SYMBOLS

10: game server (information processing device), 10A: game server (information processing device), 10B: game server (the other information processing device), 90: execution means, 92: first determination means, 94: instruction means, 96: second determination means, 98: switching mean

1. An information processing device capable of communicating with a terminal device operated by a user, comprising:
an execution means for executing a program and transmitting execution results to the terminal devices as a request source when receiving the execution request from the terminal devices,
a first determination means for determining, in the middle of execution of the program, whether or not the state of execution is a prior state of a predetermined switching state,
an instruction means for outputting an instruction for causing the other information processing device having the different performances compared with the information processing device to execute the program in the case of a positive determination by the first determination means,
a second determination means for determining whether or not the state of execution is the predetermined switching state after the instruction, and
a switching means for switching a transmission source for transmitting execution results of the program to the terminal devices from the execution means to the other information processing device in the case of the positive determination by the second determination means.

2. The information processing device according to claim 1, wherein the instruction means outputs an instruction for causing an information processing device having a higher performance than that of the information processing device, as the other information processing device, to execute the program.

3. The information processing device according to claim 1, wherein the instruction means outputs an instruction for causing an information processing device having a lower performance than that of the information processing device, as the other information processing device, to execute the program.

4. The information processing device according to claim 2, wherein the switching means ends the communication connection with the terminal device after switching the transmission source from the execution means to the other information processing device.

5. The information processing device according to claim 1, wherein the program is a game program, and
the predetermined switching state includes a state in which a scene of a game is switched.

6. An execution switching system comprising:
a plurality of information processing devices including the information processing device according to claim 2, and
a server device,
wherein the server device comprises
a search means for searching the information processing device capable of executing the program indicated by identification information among the plurality of information processing devices when a search request including the identification information of the program is received from the terminal device, and
a connection instruction means for outputting a connection instruction to the terminal device so as to preferentially connect the information processing device having the lowest performance among the information processing devices searched by the search means.

7. The information processing device according to claim 3, wherein the switching means ends the communication connection with the terminal device after switching the transmission source from the execution means to the other information processing device.

8. The information processing device according to any one of claim 2, wherein the program is a game program, and
the predetermined switching state includes a state in which a scene of a game is switched.

9. The information processing device according to any one of claim 3, wherein the program is a game program, and
the predetermined switching state includes a state in which a scene of a game is switched.

10. The information processing device according to any one of claim 4, wherein the program is a game program, and
the predetermined switching state includes a state in which a scene of a game is switched.
